(19) United States
(12) Patent Application Publication
(10) Pub. No.: US 2015/0323906 A1
(43) Pub. Date: Nov. 12, 2015

(54) TIMEPIECE AND POWER SAVING METHOD THEREOF

(71) Applicant: Princo Middle East FZE, Dubai (AE)

(72) Inventors: Chih-kuang YANG, Hsinchu (TW); Cheng-yi CHANG, Hsinchu (TW)

(21) Appl. No.: 14/671,684

(22) Filed: Mar. 27, 2015

(30) Foreign Application Priority Data
May 6, 2014 (TW) 103116154

(51) Int. Cl. G04G 19/12; G04G 9/00

(52) U.S. Cl. CPC G04G 19/12; G04G 9/0017

(57) ABSTRACT

Disclosed are a timepiece and a power saving method of a timepiece. The timepiece includes a display, a setting module, a sensor and a controller. The display is utilized for displaying a time pattern. The setting module is utilized for setting a normal display mode and a first power saving mode. The sensor is utilized for sensing an operation of a user for transmitting a signal. The controller is utilized for switching the display between the normal display mode and the first power saving mode according to the setting of the setting module and the signal of the sensor. The display changes the time pattern when the timepiece is switched between the normal display mode and the first power saving mode. The present invention can decrease the power consumption for extending the usage time of the timepiece.

### CROSS-REFERENCE TO RELATED APPLICATION

This application claims priority from and the benefit under 35 U.S.C. §119(a) of Taiwanese Patent Application No. 103116154, filed on May 6, 2014 in the TIPO (Taiwan Intellectual Property Office), which is hereby incorporated by reference for all purposes as if fully set forth herein.

### BACKGROUND OF THE INVENTION

1. Field of the Invention

The present invention generally relates to a timepiece field, and more particularly to a timepiece capable of decreasing power consumption and a power saving method thereof.

2. Description of Prior Art

With the advancements of technology, functions of a smart phone are rapidly changing, and the smart phone has various applications with different functions. Nowadays, partial functions and characteristics of the smart phone are established in a timepiece (e.g. a watch), which can be called a smart watch. The smart watch, which is different from a traditional mechanical watch, a quartz watch, or a digital watch, comprises a display capable of displaying a color image. The display is utilized for displaying a time and further utilized for displaying a plurality of applications. The display has a function of displaying the color image and further has a touch function. A user can operate the smart watch via the touch function of the display.

However, when the functions of the smart watch are more, required functions of electronic components are powerful and a required number of the electronic components is large. When the required functions of the electronic components are powerful and the required number of the electronic components is large, it means that required power consumption is increasing. Further, when the display displays a high quality image, the power consumption is more increasing. If the display has to be used for a long time, the required capacity of a battery is larger. However, a battery of the smart watch cannot be too large. The large-size and overweight battery result in the increasing of the area and the weight of the smart watch, and thus the user's desire to use the smart watch is significantly reduced.

Accordingly, it is necessary to design a power saving mechanism and a method of the smart phone for reducing the rate of the power consumption and extending the usage time of the smart watch, so that the user need not charge the smart watch frequently.

### SUMMARY OF THE INVENTION

An objective of the present invention is to provide a timepiece. The timepiece has a power saving mechanism for decreasing power consumption and extending usage time of the timepiece.

To achieve the above-mentioned objective, the present invention provides a timepiece, which comprises: a display, a setting module, a sensor and a controller. The display is utilized for displaying a time pattern. The setting module is utilized for setting a normal display mode and a first power saving mode. The sensor is utilized for sensing an operation of a user for transmitting a signal. The controller is utilized for switching the display between the normal display mode and the first power saving mode according to the setting of the setting module and the signal of the sensor. The display changes the time pattern when the timepiece is switched between the normal display mode and the first power saving mode.

Another objective of the present invention is to provide a power saving method of a timepiece. A display method of the timepiece is switched for achieving the power saving purpose by utilizing the power saving method.

According to the above-mentioned objective, the present invention provides a power saving method of a timepiece, which comprises: a display of the timepiece displaying a high quality image in a normal display mode; switching the timepiece from the normal display mode to a first power saving mode when a sensor of the timepiece receives no action of the timepiece after a first predetermined time; switching the display from the high quality image to a black and white image or a gray level image in the first power saving mode; and manually or automatically switching the timepiece from the first power saving mode to the normal display mode.

### BRIEF DESCRIPTION OF THE DRAWINGS

FIG. 1 depicts a block diagram of a timepiece in accordance with a preferred embodiment of the present invention.

FIG. 2A depicts the timepiece in a normal display mode in accordance with the present invention.

FIG. 2B depicts the timepiece in a first power saving mode in accordance with the present invention.

FIG. 2C depicts the timepiece in another first power saving mode in accordance with the present invention.

FIG. 2D depicts the timepiece in a second power saving mode in accordance with the present invention.

FIG. 3A depicts a display component of the timepiece in accordance with a preferred embodiment of the present invention.

FIG. 3B depicts a display time of the display component of the timepiece in accordance with a preferred embodiment of the present invention.

FIG. 4 depicts a flowchart of a power saving method of the timepiece in accordance with a preferred embodiment of the present invention.

### DETAILED DESCRIPTION OF THE INVENTION

The respective embodiments of a timepiece and a power saving method thereof provided by the present invention are described with referring to appended figures.

The following embodiments are referring to the accompanying drawings for exemplifying specific implementable embodiments of the present invention. Furthermore, directional terms described by the present invention, such as upper, lower, front, back, left, right, inner, outer, side and etc., are only directions by referring to the accompanying drawings, and thus the used directional terms are used to describe and understand the present invention, but the present invention is not limited thereto.

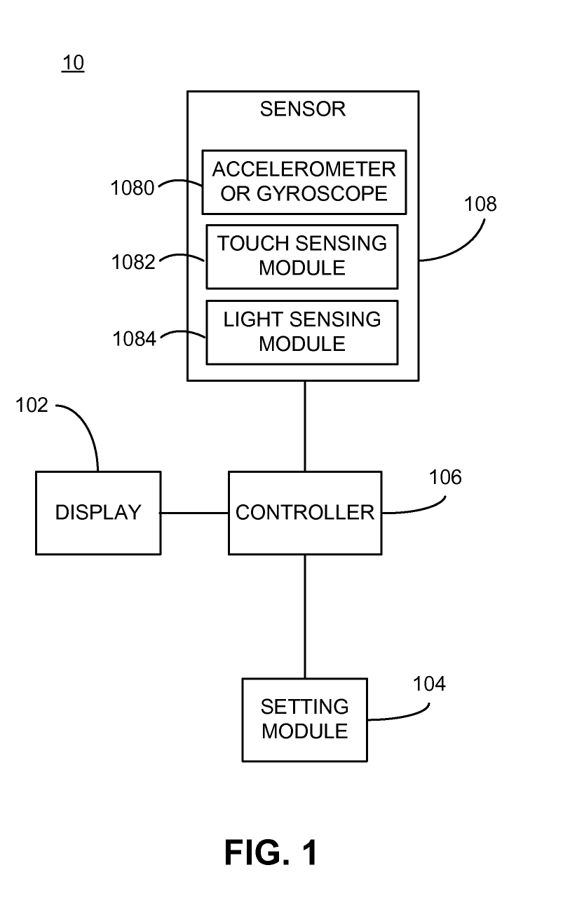

Please refer to FIG. 1. FIG. 1 depicts a block diagram of a timepiece 10 in accordance with a preferred embodiment of the present invention. As shown in FIG. 1, the timepiece 10 mainly comprises a display 102, a setting module 104, a controller 106 and a sensor 108. The display 102 is mainly utilized for displaying a time pattern, for example, a second hand, a minute hand and an hour hand of a clock or a digital time. The setting module 104 is utilized for setting a start time of a standby mode, a start time of a sleep mode and a start mechanism of a normal display mode. The controller 106 is utilized for controlling a display state of the display 102 in the normal display mode, the standby mode or the sleep mode. The sensor 108 is utilized for sensing an action of the timepiece 10. For example, when the timepiece 10 is in the standby mode or the sleep mode and then the timepiece 10 is shook, the sensor 108 sensors a shaking action and transmits at least one signal to the controller 106 for informing the controller 106. Then, the controller 106 switches the display 102 from the standby mode or the sleep mode to the normal display mode. When the display 102 is in the normal display mode and the controller 106 does not receive the signal transmitted from the sensor 108 in a first predetermined time, that is, the sensor 108 does not sense any action of the timepiece 10, the controller 106 switches the display 102 from the normal display mode to a first power saving mode which is also called the standby mode. Then, when the controller 106 still does not receive the signal transmitted from the sensor 108 after a second predetermined time, the controller 106 switches the display 102 from the first power saving mode to a second power saving mode which is also called the sleep mode.

Still referring to FIG. 1, the normal display mode of the display 102 means that the display 102 displays a color image, and meanwhile the power consumption is maximum. In the standby mode, the time pattern displayed by the display 102 is a black and white image or a gray level image. The time pattern only displays the hour hand and the minute hand and does not display the digital time. Alternatively, the time pattern only displays the digital time and does not display a full color image, thereby reducing the power consumption of the display 102. In the sleep mode of the display 102, the display 102 does not display the time pattern or the digital time. That is, the display 102 is in the sleep state. It is noted that the sensor 108 may comprise an accelerometer or a gyroscope 1080 having a function of sensing an action for sensing the shaking action of the timepiece 10. Alternatively, the sensor 108 may also comprise a touch sensing module 1082. When a user touches the display 102, the display 102 can be switched from the standby mode or the sleep mode tO the normal display mode. In another embodiment, the sensor 108 may also comprise a light sensing module 1084 for sensing light. In the evening or in an indoor environment without light, the timepiece 10 can be automatically switched from the normal display mode to the sleep mode or switched from the normal display mode to the standby mode and then to the sleep mode when the light sensing module 1084 of the sensor 108 does not sense the light. Furthermore, the timepiece 10 can be switched from the sleep mode or the standby mode to the normal display mode when the timepiece 10 is in an environment with plenty of light (i.e. a bright environment) from a dark environment and the light sensing module 1084 of the sensor 108 senses the changes of the light. It is noted that the definitions of plenty of light (i.e. the bright environment) and the dark environment may be based on the degrees of the environment light received by the light sensing module 1084 (e.g. a sensing integrated circuit (IC)). Specifically, a threshold voltage is set in advance. When a voltage which is converted from the received environment light is less than the threshold voltage, the timepiece 10 is in the dark environment. When the voltage which is converted from the received environment light is greater than the threshold voltage, the timepiece 10 is in the environment with plenty of light (i.e. the bright environment). The definitions and the determinations of the dark environment and the environment with plenty of light (i.e. the bright environment) are known for one skilled in the art of the present invention. Furthermore, the display 102 of the present invention may be a liquid crystal display (LCD) or an active-matrix organic light-emitting diode (AMOLED) display. One display capable of displaying a high quality image may serve as the display 102 of the present invention, but the present invention is not limited thereto.

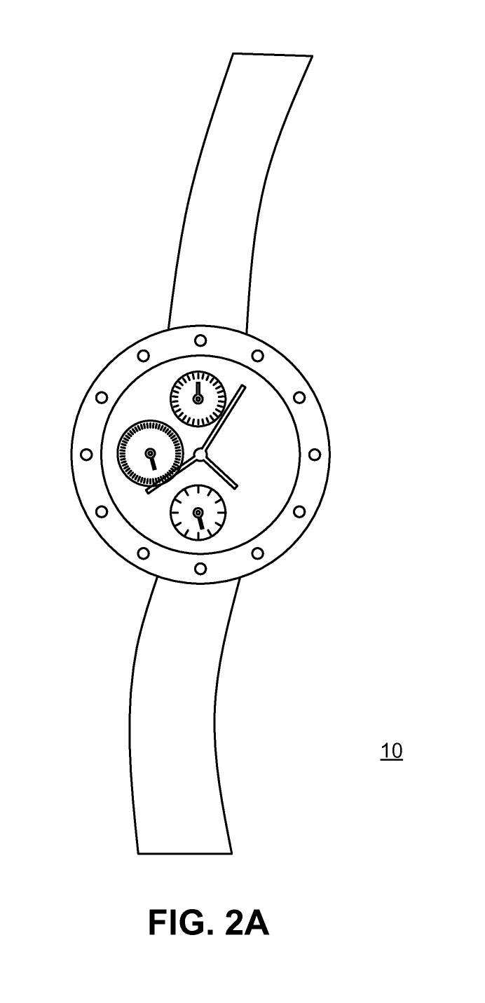

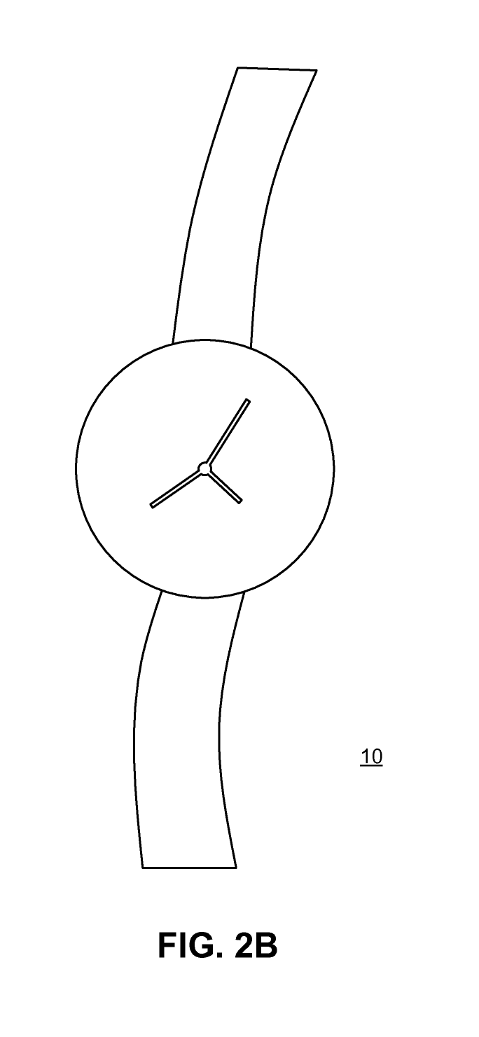

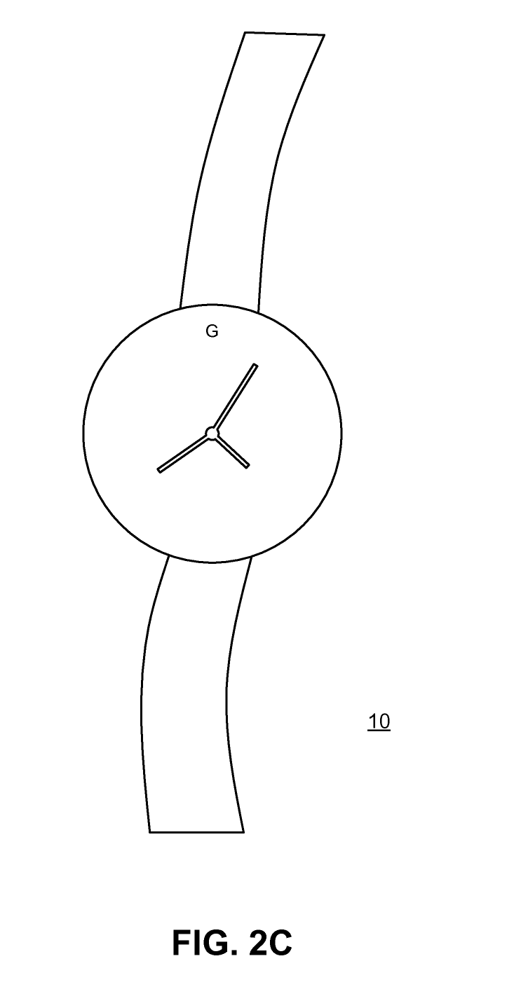

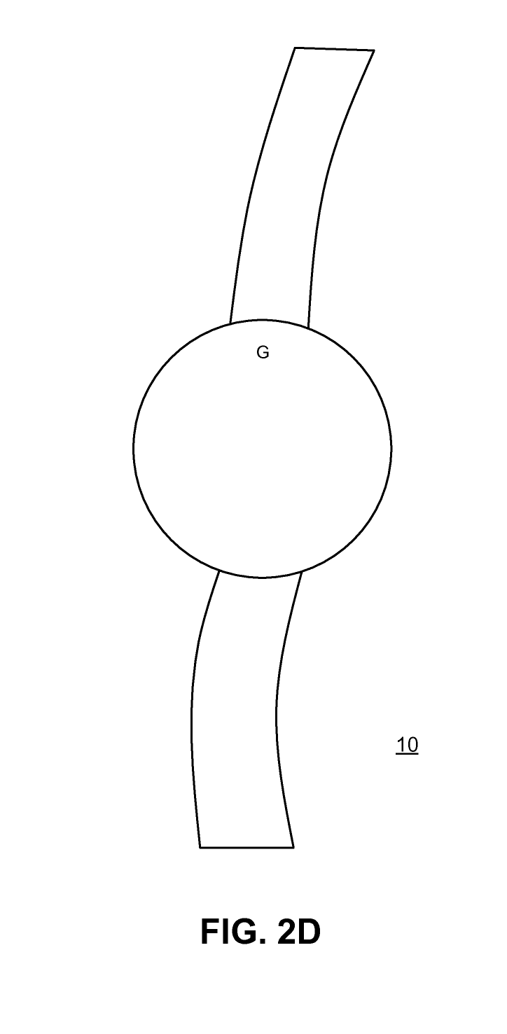

FIG. 2A depicts the timepiece 10 in the normal display mode in accordance with the present invention. The following descriptions are provided with referring to the numerals in FIG. 1. As shown in FIG. 2A, the resolution of the display 102 can be full high definition or more with the rapid enhancement of the thin film display technology. Accordingly, a simulating pattern showing rotations of gears of a mechanical watch can be displayed, and thus it looks like that the user wears a real mechanical watch. However, in the normal display mode, the power consumption of displaying a color image is maximum. When the timepiece 10 remains in the normal display state for a long time, the rate of the power consumption rate is fast. Accordingly, a battery of the timepiece 10 runs down and needs to be charged. In the present invention, when the sensor 108 built in the timepiece 10 does not receive an instruction from the timepiece 10 or does not sense an action of the timepiece 10, the controller 106 determines that the timepiece 10 can be switched from the normal display mode to the first power saving mode (e.g. the standby mode). Then, the controller 106 controls the display 102 to be switched to the standby mode. In another embodiment, the power consumption can be decreased according to the time display characteristics of the timepiece 10. For example, since a display change frequency of the hour hand, minute hand or second hand is far lower than a screen refresh frequency of the display 102, the screen refresh frequency of the display 102 of the timepiece 10 can be decreased according to the display change frequency (e.g. every 15 seconds or lower) of the hour hand, the minute hand or the second hand of the timepiece 10. By decreasing the screen refresh frequency of the display 102, the power consumption of a scan circuit of the display 102 can be decreased, and the effect of decreasing the power consumption of the timepiece 10 can be achieved. The screen refresh frequency of the display 102 of the timepiece 10 can be decreased in the normal display mode or the first power saving mode, thereby decreasing the power consumption of the scan circuit of the display 102 of the timepiece 10.

FIG. 2B depicts the timepiece 10 in the first power saving mode in accordance with the present invention. As shown in FIG. 2B, when the timepiece 10 is in the standby mode, the display 102 is switched from the full high definition state to the black and white state or the gray level state. In this mode, the display 102 only displays the hour hand, the minute hand and the second hand of the clock and does not display other patterns or digits. Alternatively, the time is shown with digits for achieving the power saving purpose. However, in the first power saving mode in another embodiment, besides displaying the hour hand, the minute hand and second hand of the clock, the timepiece 10 can display a specific image, such as a representative image of the timepiece 10 (a sign or a logo of a brand) as shown in FIG. 2C. In the standby mode, the screen refresh frequency of the hour hand and minute hand of the timepiece 10 can be decreased. For example, the setting of the screen refresh frequency of the minute hand is 5 times per second or lower, and the setting of the screen refresh frequency of the hour hand is 4 times per minute or lower. The setting of the screen refresh frequency described herein is utilized for decreasing the screen refresh frequency of the display 102 for decreasing the power consumption of the scan circuit. Alternatively, the setting of the screen refresh frequency can be based on a multiple of the hour hand or the minute hand, so that the display state of the hour hand and the minute hand remains unchanged for a long time, and only the display state of the second hand changes for decreasing the power consumption of the timepiece 10. Based on the setting instruction of the setting module 104, when the controller 106 does not receive any signal after another predetermined time, the controller 106 informs that the display 102 can be switched from the standby mode to the sleep mode. FIG. 2D depicts the timepiece 10 in accordance with the present invention in the second power saving mode. As shown in FIG. 2D, when the timepiece 10 is in the sleep mode, the display 102 of the timepiece 10 is turned off. The display 102 does not display any pattern. Alternatively, the timepiece 10 can only display a sign or a logo of a brand thereof. The sign or the logo of the timepiece 10 can be displayed fixedly or flickeringly, and the display method thereof is not limited.

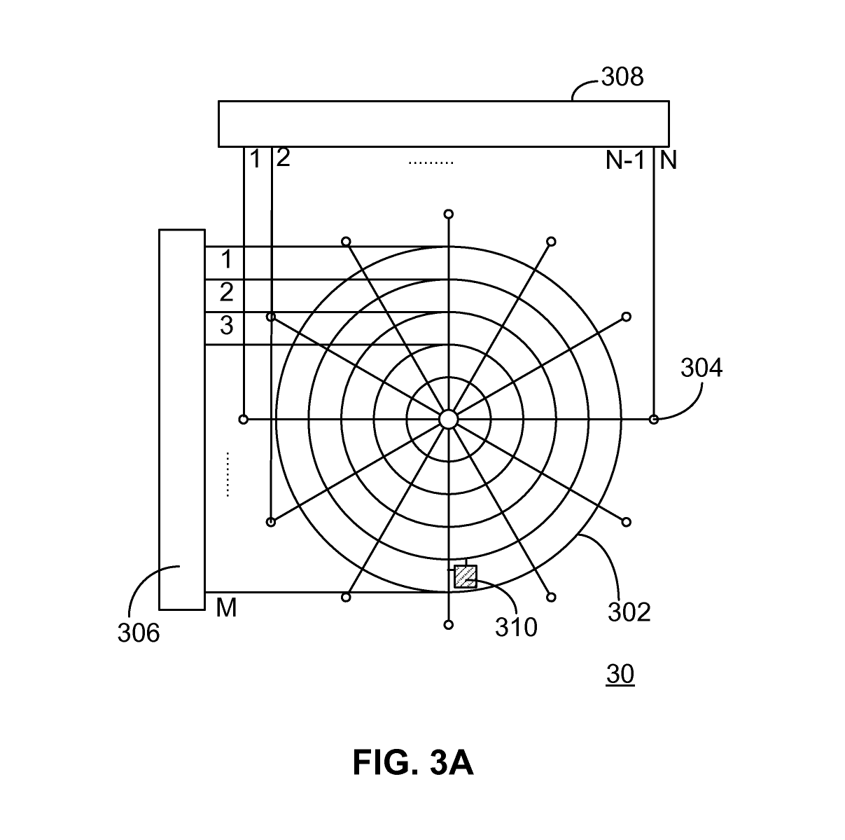

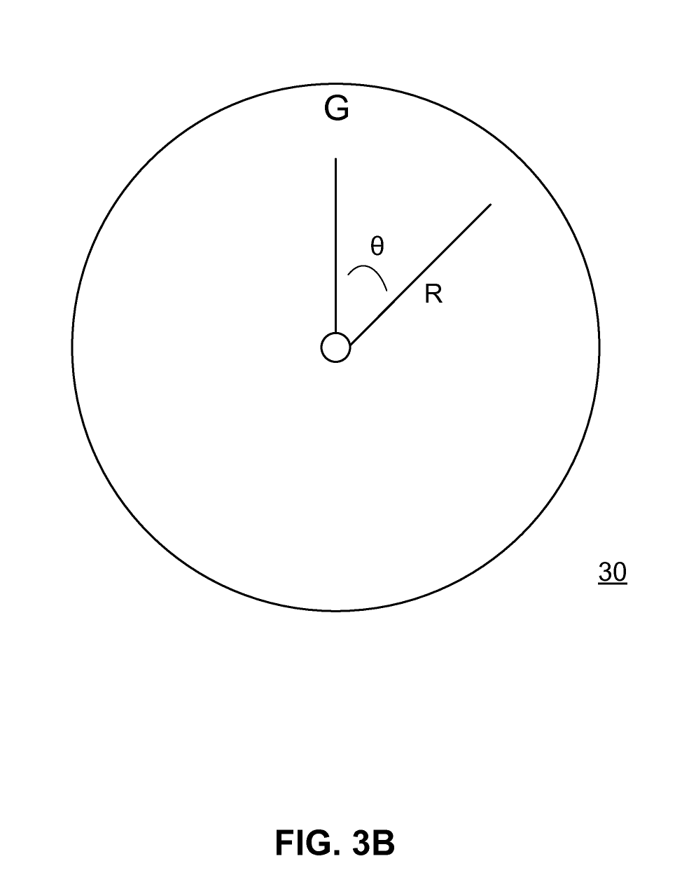

FIG. 3A depicts a display component of the timepiece in accordance with a preferred embodiment of the present invention. FIG. 3B depicts a display time of the display component of the timepiece in accordance with a preferred embodiment of the present invention. Besides the above-mentioned switches of the power saving modes, the timepiece 10 of the present invention further comprises a display component 30. The power saving of the timepiece 10 can be achieved by controlling the driving of the display component 30. As mentioned above, the display component 30 of the timepiece 10 may be a liquid crystal display (LCD) or an active-matrix organic light-emitting diode (AMOLED) device and comprises M scan lines 302 and N data lines 304. The M scan lines 302 are arranged concentrically. The N data lines 304 are arranged radially. The scan lines 302 are electrically coupled to a scan driving circuit 306 which provides scan signals. The data lines 304 are electrically coupled to a data driving circuit 308 which provides data signals. The scan lines 302 and the data lines 304 define a plurality of pixels 310. Each of the pixels 310 defined by the scan lines 302 and the data lines 304 is corresponding to a polar coordinate. External endpoints of the scan lines 302 are sequentially scanned and turned on along radii R in a high frequency. The data lines 304 are sequentially scanned in a clockwise direction, and the data driving circuit 308 sequentially turns on external endpoints of the data lines 304 according to angles θ. Each pixel 310 is electrically turned on and then lighting, and the power consumes only when the corresponding scan line 302 and the corresponding data line 304 are turned on simultaneously. The present invention is capable of decreasing a number and a frequency of the pixels 310 which are turned on. For example, when the minute hand is displayed, the external endpoints of the scan lines 302 are sequentially scanned and turned on along the radii R in the high frequency. The data lines 304 are sequentially scanned in the clockwise direction, and the data driving circuit 308 sequentially turns on the external endpoints of the data lines 304 according to the angles θ. The data line 304 at a specific angle θ is switched to the next data line 304 at the angle θ+1° per minute or per half minute. As a result, the number and the frequency of the pixels 310 which are turned on can be decreased significantly. The refresh frequency of the data lines 304 is lower when the hour hand is displayed. One data line 304 at a specific angle θ is switched to the angle θ+1° per 15 minutes or a slower time. Comparing with the pixels refreshed in a high frequency in the prior art, the display component 30 of the timepiece 10 of the present invention can decrease the refresh frequency of the pixels 310, thereby decreasing the power consumption.

Furthermore, it is noted that the switch time (i.e. the first predetermined time) from the normal display mode to the standby mode can be adjusted. The user can set the first predetermined time with a touch operation on the display 102 of the timepiece 10 or with a button of the timepiece 10. For example, when the timepiece 10 does not receive any action in 15 minutes, the timepiece 10 is switched from the normal display mode/standby mode to the standby mode/sleep mode. Then, the timepiece 10 can be adjusted to be switched from the normal display mode to the standby mode when the timepiece 10 does not receive any action in 10 minutes. Further, in another embodiment, the user can manually switch the timepiece 10 from the normal display mode to the standby mode. For example, when the user watches the current time from the timepiece 10 and then need not use the timepiece 10, the user can switch the timepiece 10 to the standby mode or the sleep mode. Moreover, the timepiece 10 can be switched from the normal display mode to the standby mode or the sleep mode with a touch operation or a button of the timepiece 10. The above-mentioned standby mode and the sleep mode are only examples of power saving modes of the timepiece 10. hi another embodiment, the timepiece 10 of the present invention can only have one of the standby mode and the sleep mode, or the timepiece 10 of the present invention can have another power saving mode excluding the standby mode and the sleep mode.

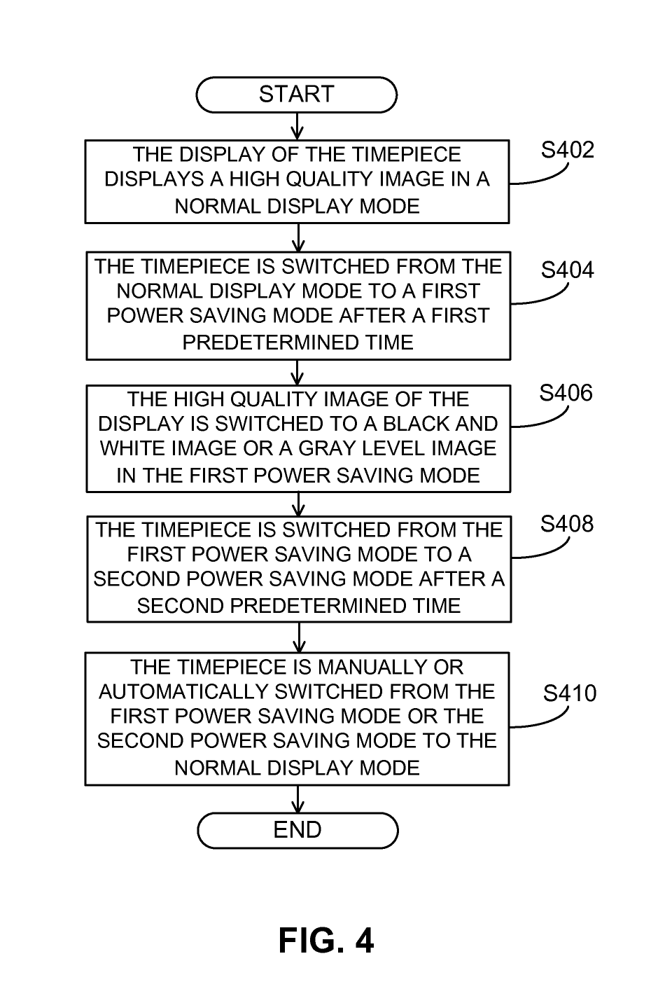

FIG. 4 depicts a flowchart of a power saving method of the timepiece in accordance with a preferred embodiment of the present invention. The following descriptions of the steps are provided with referring to the numerals in FIG. 1. As shown in FIG. 4, in step S402, the display 102 of the timepiece 10 displays a high quality image in a normal display mode. The high quality image of the timepiece 10 may be a high color image, a full color image or a full high definition image. Any methods of displaying the high quality image can be utilized in the display 102 of the present invention and are not limited. One color of a high color image is represented by 16 bits. One color of a full color image is represented by 32 bits. The resolution of the full high definition image is 1920×1080. In step S404, the timepiece 10 is switched from the normal display mode to a first power saving mode after a first predetermined time. The controller 106 receives at least one signal from the sensor 108 for determining whether an action of the timepiece 10 occurs. When there is no action, the timepiece 10 is switched from the normal display mode to the first power-saving mode. In step S406, the high quality image of the display 102 is switched to a black and white image or a gray level image in the first power saving mode. Any power saving method of displaying the black and white image or the gray level image can be utilized in the first power saving mode of the display 102 of the present invention and is not limited. In step S408, the timepiece 10 is switched from the first power saving mode to a second power saving mode after a second predetermined time. The display 102 displays no image or only displays a sign or a logo of a brand of the timepiece 10. It is noted that step S408 is optional. In step S410, the timepiece 10 is manually or automatically switched from the first power saving mode or the second power saving mode to the normal display mode. A manual method is to touch the display 102 with a finger of the user for waking up the display 102 of the timepiece 10 or to utilize a button of the timepiece 10 for waking up the display 102 of the timepiece 10. An automatic method is to set timing (e.g. an alarm clock) for waking up the display 102 of the timepiece 10 after a predetermined time. The above-mentioned power saving method of the timepiece 10 can increase the usage time of the battery of the timepiece 10, and thus the user need not frequently charge the battery of the timepiece 10. The power saving method of the timepiece of the present invention further comprises a step of adjusting a screen refresh frequency of displaying the hour hand and minute hand of the timepiece 10 for decreasing the power consumption of the timepiece 10. Adjusting the screen refresh frequency of displaying the hour hand and minute hand of the timepiece 10 is utilized not only in the first power saving method and the second power saving method but also in the normal display mode.

The above-mentioned power saving method of the timepiece can increase the usage time of the battery of the timepiece without the premise of increasing the capacity of the battery, and thus the user need not frequently replace or charge the battery, so that the timepiece with the high quality display can be accepted by general users.

As is understood by a person skilled in the art, the foregoing preferred embodiments of the present invention are illustrative rather than limiting of the present invention. It is intended that they cover various modifications and similar arrangements be included within the spirit and scope of the appended claims, the scope of which should be accorded the broadest interpretation so as to encompass all such modifications and similar structure.

What is claimed is:

1. A timepiece, comprising:
a display utilized for displaying a time pattern;
a setting module utilized for setting a normal display mode and a first power saving mode;
a sensor utilized for sensing an operation of a user for transmitting a signal; and
a controller utilized for switching the display between the normal display mode and the first power saving mode according to the setting of the setting module and the signal of the sensor,
wherein the display changes the time pattern when the timepiece is switched between the normal display mode and the first power saving mode.

2. The timepiece according to claim 1, further comprising a display component, and the display component comprising:
a plurality of scan lines arranged concentrically; and
a plurality of data lines arranged radially,
wherein the scan lines and the data lines of the display component drive a plurality of pixels for achieving display effect of the timepiece.

3. The timepiece according to claim 2, further adjusting a screen refresh frequency of the timepiece according to a display of an hour hand or a minute hand of the timepiece for decreasing power consumption of the timepiece.

4. The timepiece according to claim 1, wherein the sensor comprises an accelerometer or a gyroscope for detecting the operation of the user.

5. The timepiece according to claim 1, wherein the sensor comprises a touch sensing module for the user to manually switch the timepiece between the normal display mode and the first power saving mode.

6. The timepiece according to claim 1, wherein the sensor comprises a light sensing module for the timepiece to be automatically switched between the normal display mode and the first power saving mode when the timepiece is in a bright environment or in a dark environment.

7. The timepiece according to claim 1, further decreasing a screen refresh frequency of the display for decreasing power consumption of the timepiece.

8. The timepiece according to claim 1, further decreasing a screen refresh frequency of displaying an hour hand or a minute hand of the timepiece.

9. The timepiece according to claim 1, wherein the time pattern of the timepiece is a full color image in the normal display mode, and the time pattern of the timepiece is a black and white image or a gray level image in the first power saving mode.

10. The timepiece according to claim 1, further having a second power saving mode, wherein the timepiece stops displaying the time pattern in the second power saving mode, and the user automatically or manually switches the timepiece from the first power saving mode or the second power saving mode to the normal display mode.

11. The timepiece according to claim 1, wherein the display is an active-matrix organic light-emitting diode display.

12. The timepiece according to claim 1, wherein the setting module further sets a switch time between the normal display module and the first power saving mode.

13. A power saving method of a timepiece, comprising:
a display of the timepiece displaying a high quality image in a normal display mode;
switching the timepiece from the normal display mode to a first power saving mode when a sensor of the timepiece receives no action of the timepiece after a first predetermined time;
switching the display from the high quality image to a black and white image or a gray level image in the first power saving mode; and
manually or automatically switching the timepiece from the first power saving mode to the normal display mode.

14. The power saving method of the timepiece according to claim 13, wherein a controller of the timepiece receives at least one signal from the sensor for determining whether the action of the timepiece occurs, and the timepiece is switched from the normal display mode to the first power saving mode when the action does not occur.

15. The power saving method of the timepiece according to claim 13, wherein the step of manually switching the timepiece from the first power saving mode to the normal display mode is to touch the display with a touch sensing method for waking up the display of the timepiece.

16. The power saving method of the timepiece according to claim 13, wherein the step of manually switching the timepiece from the first power saving mode to the normal display mode is to utilize a button of the timepiece for waking up the display of the timepiece.

17. The power saving method of the timepiece according to claim 13, wherein the step of automatically switching the timepiece from the first power saving mode to the normal display mode is to set timing for waking up the display of the timepiece after a predetermined time.

18. The power saving method of the timepiece according to claim 13, after the step of switching the display normal display mode to the first power saving mode, the power saving method of the timepiece further comprising:
switching the timepiece from the first power saving mode to a second power saving mode after a second predetermined time; and
manually or automatically switching the timepiece from the first powersaving mode or the second power saving mode to the normal display mode.

19. The power saving method of the timepiece according to claim 18, wherein the timepiece turns off the display in the second power saving mode.

20. The power saving method of the timepiece according to claim 13, further comprising a step of adjusting a screen refresh frequency of the timepiece according to a display of an hour hand or a minute hand of the timepiece for decreasing power consumption of the timepiece.
